(19) United States
(12) Patent Application Publication
(10) Pub. No.: US 2011/0292680 A1
(43) Pub. Date: Dec. 1, 2011

(54) LIGHT GUIDE UNIT AND LIGHT SOURCE MODULE

(75) Inventor: Han-Wen Tsai, Hsin-Chu (TW)

(73) Assignee: CORETRONIC CORPORATION, Hsin-Chu (TW)

(21) Appl. No.: 13/113,074

(22) Filed: May 22, 2011

(30) Foreign Application Priority Data
Jun. 1, 2010 (CN) 201010194547.1

(51) Int. Cl. F21V 7/22; G02B 6/26; G02B 6/10

(52) U.S. Cl. 362/607; 385/129; 385/27

(57) ABSTRACT

A light guide unit having a planar portion, a first curved portion, and a second curved portion are disclosed. The first curved portion has a first optical surface, a second optical surface, and a light incident surface connecting the first and the second optical surfaces. The planar portion has a first and a second surfaces, respectively, connected to the first and the second optical surfaces. Absolute values of slopes of the first and second optical surfaces with respect to the first and second surfaces gradually increase near to the light incident surface, respectively. The planar portion connects the first and the second curved portions having a third surface and a third optical surface, and the second surface connects the second and the third optical surfaces. An absolute value of a slope of the third optical surface with respect to the second surface gradually increases away from the first surface.

### CROSS-REFERENCE TO RELATED APPLICATION

This application claims the priority benefit of China application serial no. 201010194547.1, filed on Jun. 1, 2010. The entirety of the above-mentioned patent application is hereby incorporated by reference herein and made a part of this specification.

### BACKGROUND OF THE INVENTION

1. Field of the Invention

The invention relates to an optical unit and a light source module employing the optical unit, and more particularly to a light guide unit and a light source module employing the light guide module.

2. Description of Related Art

In general, in order to apply the high dynamic range (HDR) display technology in displays such as liquid crystal displays (LCDs), a backlight module is usually divided into multiple backlight areas (i.e. a M*N backlight structure) for local dimming. Each backlight area of the backlight module may include a light guide plate to guide a light beam.

However, in the most of the current backlight modules with local dimming scheme, a light guide system of a complete backlight module is provided by partially overlapping the adjacent light guide plates and combining the light guide plates of all backlight areas. Because the light guide plates of the adjacent backlight areas partially overlap with each other, rubbing may occur at the overlapping area, and misalignment may occur due to shock thus resulting in a poor reliability. In addition, in order to overcome these defects, the mechanical design may be more difficult.

Besides the above defects, light reflection tends to occur at the joining area where the light guide plates of adjacent backlight areas overlap. This may cause light beams to directly emerge out of the light guide plate to form multiple bright lines, thus degrading the illumination uniformity of the backlight module.

Taiwan Patent No. M281195 discloses a light guide plate having a light mixing area and a light emerging area. The light emerging area is adjacent the light mixing area. The light emerging area and the light mixing area are configured as a step structure, and the light mixing area of an adjacent light guide plate is overlappingly disposed below the light emerging area. In addition, Taiwan Patent No. I294531 discloses a light guide member having a light incident area. Edges of adjacent light guide members may be connected by adhesive or injection.

In addition, U.S. Pat. No. 7,311,431 discloses a light guide plate having a first end and a second end. The second end of the light guide plate is disposed on the first end of an adjacent light guide plate. U.S. Patent Application Publication No. 2009290097 discloses a light guide plate including a body and a light incident area. The body is overlappingly disposed on the light incident area of an adjacent light guide plate. U.S. Patent Application Publication No. 2005168967 discloses a light source apparatus. A light source is disposed at a light incident side of a first light guide plate of the light source apparatus. A distal end of the first light guide plate is connected with the light incident side of a second light guide plate. A second light source is disposed at the light incident side of the second light guide plate and below the first light guide plate.

### SUMMARY OF THE INVENTION

Accordingly, the invention is directed to a light guide unit, and the light guide unit has a reduced thickness and is capable of effectively guiding a light source.

The invention is also directed to a light source module employing the above light guide unit, and the light guide unit may provide improved illumination uniformity and light emerging performance.

Other objects and advantages of the invention may be further illustrated by the technical features broadly embodied and described as follows.

In order to achieve at least one of the objectives or other objectives, one embodiment of the invention provides a light guide unit having a first curved portion, a planar portion, and a second curved portion. The first curved portion having a light incident surface, a first optical surface, and a second optical surface. The light incident surface connects the first optical surface and the second optical surface. The planar portion has a first surface and a second surface opposite to the first surface. The first optical surface is connected to the first surface. An absolute value of a slope of the first optical surface with respect to the first surface gradually increases near to the light incident surface. The second surface is connected to the second optical surface. An absolute value of a slope of the second optical surface with respect to the second surface gradually increases near to the light incident surface. The second curved portion has a third surface and a third optical surface. The planar portion connects the first curved portion and the second curved portion. The first surface connects the first optical surface and the third surface. The second surface connects the second optical surface and the third optical surface. An absolute value of a slope of the third optical surface with respect to the second surface gradually increases away from the first surface.

In one embodiment of the invention, the light guide unit is capable of guiding a light beam provided by a light source. The light beam is capable of entering the light guide unit via the light incident surface. When the light beam passing the light incident surface is transmitted to the first optical surface and the second optical surface, respectively, the first optical surface and the second optical surface are adapted to partially reflect the light beam such that a portion of the light beam is transmitted to the planar portion. The planar portion is adapted to transmit a portion of the light beam to the second curved portion. A portion of the light beam not reflected by the first optical surface is capable of emerging out of the light guide unit through the first optical surface. The portion of the light beam from the first curved portion is capable of emerging out of the light guide unit through the first surface. The portion of the light beam from the planar portion is capable of being reflected by the third optical surface to the third surface to emerge out of the light guide unit through the third surface.

In one embodiment of the invention, each of the first optical surface, the second optical surface, and the third optical surface includes a smooth curved surface or a surface formed by a plurality of planes connected to one another. Each of the absolute values of slopes of the planes with respect to the first surface gradually increases away from the first surface.

In one embodiment of the invention, the light guide unit further includes a recessed portion disposed on the light incident surface of the first curved portion, and the recessed portion is recessed into the light guide unit in a direction toward the first surface.

In one embodiment of the invention, the light guide unit further includes a reflection unit disposed on at least one of the second optical surface, the second surface, and the third optical surface.

In one embodiment of the invention, the light guide unit further includes a plurality of scattering microstructures disposed on the second surface. In one embodiment, the density of the scattering microstructures gradually increases in a direction from the second optical surface toward the third optical surface.

In one embodiment of the invention, the light incident surface is substantially parallel to the first surface. In one embodiment, the third surface is substantially perpendicular to the first surface.

In one embodiment of the invention, the second curved portion further comprises a support surface connecting the third surface and the third optical surface. In one embodiment, the support surface is parallel to the light incident surface.

Another embodiment of the invention provides a light source module including a plurality of light guide units and a plurality of light sources. The light guide units are arranged in an array, and any the two adjacent light guide units do not overlap with each other. Each of the light guide units includes a first curved portion, a planar portion, and a second curved portion. The first curved portion has a light incident surface, a first optical surface, and a second optical surface. The light incident surface connects the first optical surface and the second optical surface. The planar portion has a first surface and a second surface opposite to the first surface. The first optical surface is connected to the first surface, and an absolute value of a slope of the first optical surface with respect to the first surface gradually increases near to the light incident surface. The second surface is connected to the second optical surface, and an absolute value of a slope of the second optical surface with respect to the second surface gradually increases near to the light incident surface. A second curved portion has a third surface and a third optical surface. The planar portion connects the first curved portion and the second curved portion. The first surface connects the first optical surface and the third surface. The second surface connects the second optical surface and the third optical surface. An absolute value of a slope of the third optical surface with respect to the second surface gradually increases away from the first surface. Each of the light sources is disposed adjacent to the light incident surface of a corresponding one of the light guide units, and a light beam provided by each of the light sources is capable of entering each of the light guide unit through the light incident surface thereof.

In one embodiment of the invention, a distance is maintained between the any two adjacent light guide units arranged along a particular direction. In one embodiment, the distance is substantially equal to or less than 3% of the length of each of the light guide units along the particular direction.

In one embodiment of the invention, in the light guide units arranged in a particular direction, the first optical surface of one of the light guide units arranged in the particular direction faces the third surface of the adjacent one of the light guide units arranged in the particular direction, and the first optical surface of one of the light guide units arranged in the particular direction maintains a distance from the adjacent one of the light guide units arranged in the particular direction.

In one embodiment of the invention, the light source module further includes a substrate, and the light guide units and the light sources are disposed one the substrate. In one embodiment, the substrate is provided with a plurality of grooves, and the light sources are disposed in the grooves, respectively.

In one embodiment of the invention, the light source module further includes a plurality of reflection units disposed on the substrate. Each of the reflection units is disposed between a corresponding one of the light guide units and the substrate.

In one embodiment of the invention, each of the light guide units further includes a recessed portion disposed on the light incident surface of the first curved portion, and the recessed portion is recessed into the light guide unit in a direction toward the first surface.

In summary, the embodiment or embodiments of the invention may have at least one of the following advantages. The absolute values of the slopes of the first optical surface, the second optical surface, and the third optical surface with respect to the first surface gradually increase away from the first surface. Therefore, the light beam transmitted to the optical surfaces may be partially transmitted through these optical surfaces and partially reflected by these optical surfaces. Therefore, not only the light beam provided by the light source may be utilized more effectively and directed, but also the light field formed by the light beam emerging out of the light guide units may be more uniform. In addition, because of the light guide unit including the third optical surface, when the light guide unit is used in the light source module, the possibility of forming the bright line between adjacent ones of the light guide units arranged in an array may be reduced, and thus the luminance uniformity of the surface light source provided by the light source module may be improved.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1A is a partial top view of a light source module according to one embodiment of the invention.

FIG. 1B is partial sectional view of FIG. 1A taken along line A-A′ thereof.

FIG. 2A is a top view of the light guide unit of FIG. 1A.

FIG. 2B is a partial sectional view of FIG. 2A taken along line B-B′ thereof.

FIG. 3A and FIG. 3B are partial, enlarged view of different embodiments of the first optical surface and the second optical surface of FIG. 2B, respectively.

FIG. 4 is a sectional view of another embodiment of the light guide unit of FIG. 2B.

FIG. 5 is a sectional view of another embodiment of the light guide unit of FIG. 2B.

FIG. 6 is a sectional view of still another embodiment of the light guide unit of FIG. 2B.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purposes of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

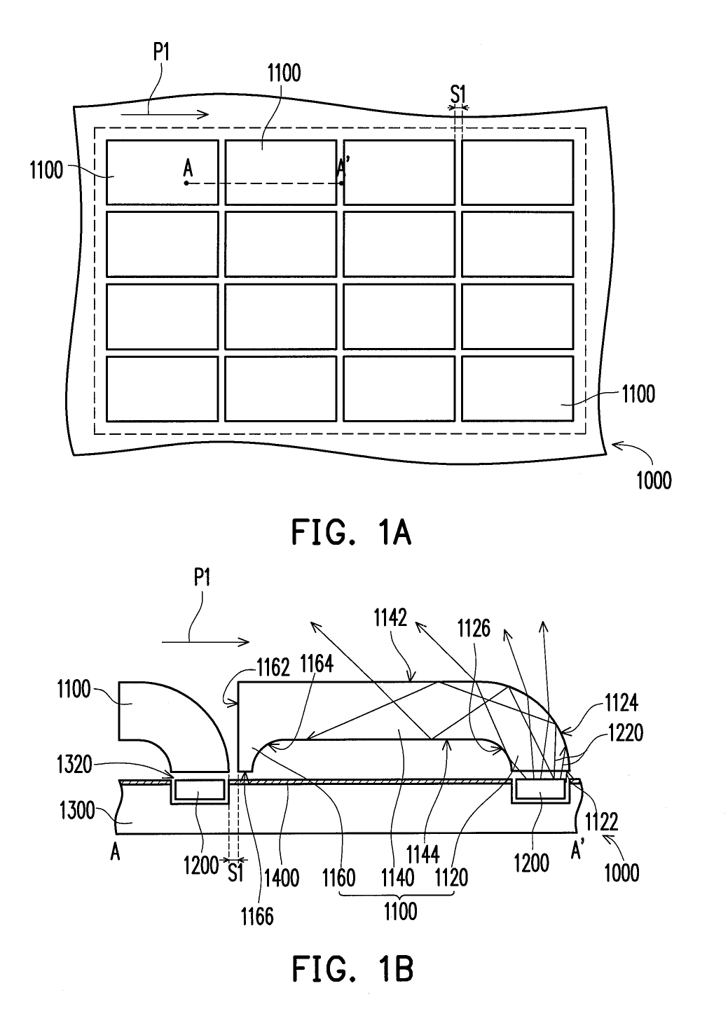

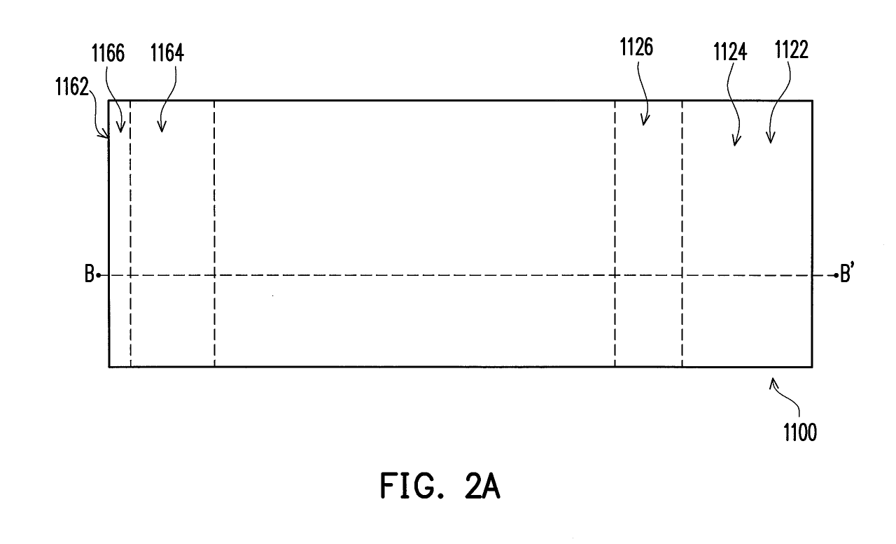

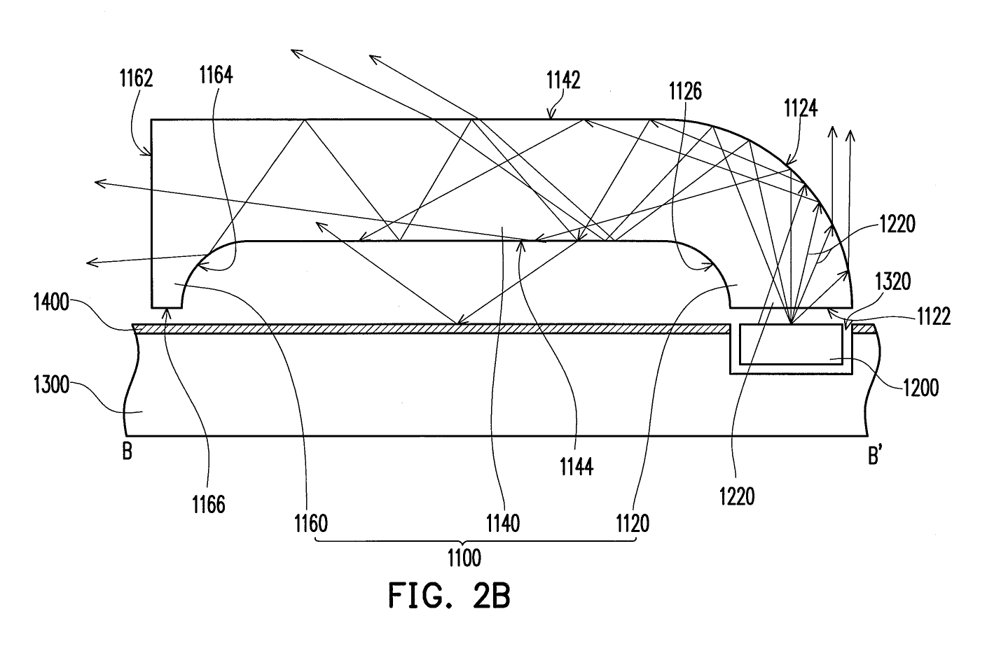

For ease of description, FIG. 1A merely illustrates an arrangement of a plurality of light guide units without showing various elements probably located above or below the light guide units. Referring to FIGS. 1A, 1B, 2A, and 2B, the light source module 1000 includes a plurality of light guide units 1100 and a plurality of light sources 1200. The light guide units 1100 are arranged in an array, and any two adjacent light guide units 1100 do not overlap each other.

In the light source module 1000, each light guide unit 1100 includes a first curved portion 1120, a planar portion 1140, and a second curved portion 1160. The first curved portion 1120 includes a light incident surface 1122, a first optical surface 1124, and a second optical surface 1126. The light incident surface 1122 connects the first optical surface 1124 and the second optical surface 1126. In addition, each light source 1200 is disposed adjacent to the light incident surface 1122 of a corresponding one of the light guide units 1100. A light beam 1220 provided by each of the light sources 1200 is capable of entering a corresponding light guide unit 1100 via the light incident surface 1122 of the corresponding light guide unit 1100, and each light guide unit 1100 is capable of guiding the light beam 1220 provided by the corresponding light source 1200, as shown in FIGS. 1B and 2B.

Specifically, when the light beam 1220 passing the light incident surface 1122 is transmitted to the first optical surface 1124 and the second optical surface 1126, respectively, the first optical surface 1124 and the second optical surface 1126 reflect a portion of the light beam 1220 to the planar portion 1140, while another portion of the light beam 1220 not reflected by the first optical surface 1124 may emerge out of the light guide plate 1100 through the first optical surface 1124, as shown in FIGS. 1B and 2B. In the embodiment, the light source module 1000 may include a substrate 1300, and the light guide units 1100 and light sources 1200 are disposed on the substrate 1300. In one implementation, the substrate 1300 may include a plurality of grooves 1320, and the light sources 1200 may be disposed in the grooves 1320, respectively, as shown in FIGS. 1B and 2B. Therefore, the light guide units 1100 may rest on the substrate 1300. Noticeably, disposing the light sources 1200 in the grooves 1320 of FIGS. 1B and 2B is for the purposes of illustration only and should not be regarded as limiting. In addition, the light sources 1200 may be light emitting diode light sources, cold cathode fluorescent lamps or other suitable light sources. In the embodiment, the light sources 1200 are illustrated as light emitting diode light sources but this should not be regarded as limiting.

In addition, the planar portion 1140 includes a first surface 1142 and a second surface 1144 opposite to the first surface 1142. The first optical surface 1124 is connected with the first surface 1142, and the absolute value of the slope of the first optical surface 1124 with respect to the first surface 1142 increases gradually near to the light incident surface 1122. The second surface 1144 is connected with the second optical surface 1126, and the absolute value of the slope of the second optical surface 1126 with respect to the second surface 1144 increases gradually near to the light incident surface 1122, as shown in FIGS. 1B and 2B. In the embodiment, the light incident surface 1122 is substantially parallel to the first surface 1142.

Specifically, due to the absolute value of the slope of the first optical surface 1124 with respect to the first surface 1142 increasing gradually near to the light incident surface 1122, when the light beam 1220 passing the light incident surface 1122 is transmitted to the first optical surface 1124, a portion of the light beam 1220 shining on the first optical surface 1124 at an incident angle larger than the angle of total reflection may be totally reflected by the first optical surface 1124 to the second optical surface 1126 or the planar portion 1140. On the contrary, a portion of the light beam 1220 shining on the first optical surface 1124 at an incident angle smaller than the angle of total reflection may emerge out of the light guide unit 1100 from the first optical surface 1124, as shown in FIGS. 1B and 2B.

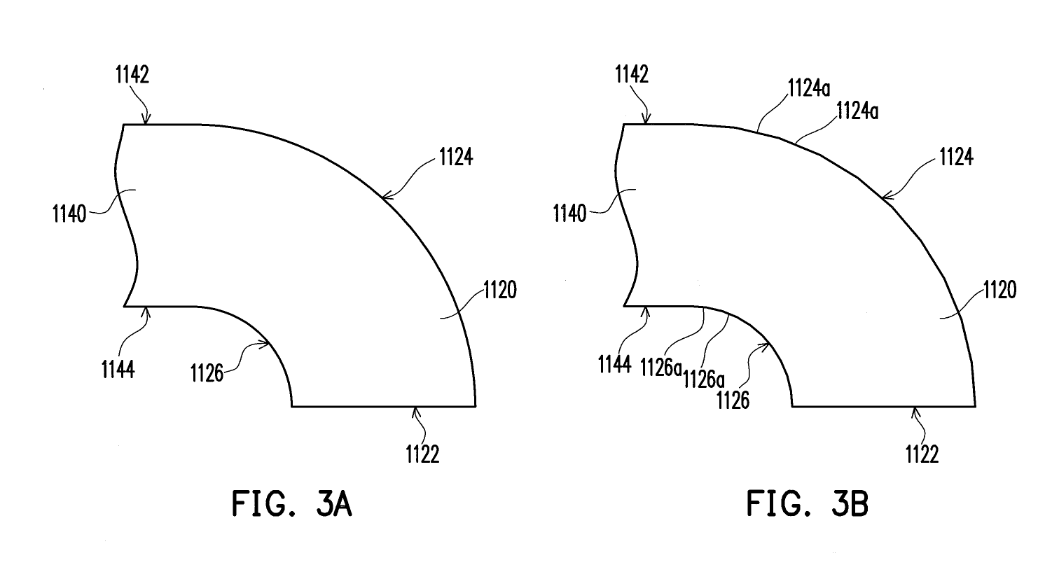

Similarly, the absolute value of the slope of the second optical surface 1126 with respect to the second surface 1144 increases gradually near to the light incident surface 1122. Therefore, when the light beam 1220 passing the light incident surface 1122 is transmitted to the second optical surface 1126, a portion of the light beam 1220 shining on the second optical surface 1126 at an incident angle larger than the angle of total reflection may be totally reflected by the second optical surface 1126 to the planar portion 1140, as shown in FIGS. 1B and 2B. In the embodiment, the first optical surface 1124 and the second optical surface 1126 may be configured as smooth curved surfaces as illustrated in FIG. 3A. In another embodiment, the first optical surface 1124 and the second optical surface 1126 may be surfaces formed by a plurality of planes 1124a connected to one another and a plurality of planes 1126a connected to one another, respectively, as illustrated in FIG. 3B, and the absolute value of the slopes of the planes 1124a and the absolute value of the planes 1126a with respect to the first surface 1142 increase gradually away from the first surface 1142, as shown in FIGS. 3B.

Referring to FIGS. 1A, 1B, 2A, and 2B, the second curved portion 1160 has a third surface 1162 and a third optical surface 1163, and the planar portion 1140 connects the first curved portion 1120 and the second curved portion 1160. In each light guide unit 1100, the first surface 1142 connects the first optical surface 1124 and the third surface 1162, and the second surface 1144 connects the second optical surface 1126 and the third optical surface 1164. The absolute value of the slope of the third optical surface 1164 with respect to the second surface 1144 increases gradually away from the first surface 1142 as shown in FIGS. 1B and 2B. In the embodiment, the third surface 1162 may be substantially perpendicular to the first surface 1142.

Specifically, the planar portion 1140 is adapted to transmit a portion of the light beam 1220 from the first curved portion 1120 to the second curved portion 1160, while a portion of the light beam 1120 not transmitted to the second curved portion 1160 is capable of emerging out of the light guide plate 1100 through the first surface 1142, as shown in FIGS. 1B and 2B. In the embodiment, in order to increase the utilization rate of the light beam 1220 of the light source 1200 and the overall light emerging performance of the light source module 1000, the light source module 1000 may further include a plurality of reflection units 1400 disposed on the substrate 1300, and each of the reflection units 1400 is disposed between a corresponding light guide unit 1100 and the substrate 1300, as shown in FIGS. 1B and 2B. As such, after passing the second optical surface 1126 or the second surface 1144, the light beam 1220 not reflected by the second optical surface 1126 or the second surface 1144 is capable of being reflected by the reflection unit 1400 and thus entering the light guide plate 1100 once again, and thereby the possibility of the light beam 1220 emerging out of the light guide unit 1100 may be increased.

In addition, when the light beam 1220 from the planar portion 1140 is transmitted to the third optical surface 1164, a portion of the light beam 1220 is capable of being reflected by the third optical surface 1164 to the third surface 1162 and thereby emerging out of the light guide unit 1100, as shown in FIGS. 1B and 2B. Specifically, the absolute value of the slope of the third optical surface 1164 with respect to the second surface 1144 increases gradually away from the first surface 1142. Therefore, when the light beam 1220 from the planar portion 1140 is transmitted to the third optical surface 1164, a portion of the light beam 1220 shining on the third optical surface 1164 at an incident angle larger than the angle of total reflection may be totally reflected by the third optical surface 1164 to the third surface 1162. On the contrary, a portion of the light beam 1220 shining on the third optical surface 1164 at an incident angle smaller than the angle of total reflection may be transmitted through the third optical surface 1164, as shown in FIGS. 1B and 2B. Likewise, since the light source module 1000 may be provided with the reflection units 1400, the portion of the light beam 1220 passing the third optical surface 1164 may be reflected by the reflection unit 1400 once again and transmitted back into the light guide unit 1100, and thereby the utilization rate of the light beam 1220 may be increased.

In the light source module 1000, the any two adjacent light guide units 1100 may be arranged along a particular direction P1 with a distance S1 formed therebetween. The distance S1 may be substantially equal to or less than 3% of the length of each of these light guide units 1100 along the particular direction P1, as shown in FIGS. 1A and 1B. Specifically, not only the distance S1 between the light guide units 1100 arranged in an array may help the light source module 1000 avoid the alignment error during assembly and the error due to thermal expansion of the material, but also an air gap between the adjacent light guide units 1100 may be formed to facilitate the first optical surface 1124 reflecting the light beam under the principle of total reflection.

In addition, in the light guide units 1100 arranged in the particular direction P1, the first optical surface 1124 of one of the light guide units 1100 arranged in the particular direction P1 faces the third surface 1162 of the adjacent one of the light guide units 1100 arranged in the particular direction P1 and maintains the distance S1 from the adjacent one of the light guide units 1100 arranged in the particular direction P1, as shown in FIG. 1B. Therefore, the light beam 1220 emerging from the third surface 1162 may be partially transmitted to the first optical surface 1124 of the adjacent light guide unit 1100, and a large portion of the light beam 1220 may be transmitted through the first optical surface 1124 and into the adjacent light guide unit 1100, whereas a small portion of the light beam 1220 is capable of emerging in a direction toward the light source module 1000. As such, not only the utilization rate of the light beam 1220 of the light source 1200 may be effectively increased, but also the possibility of forming a bright line between adjacent light guide units 1100 may be reduced when the light source module 1000 provides a surface light source, and thereby the illumination uniformity of the surface light source may be improved.

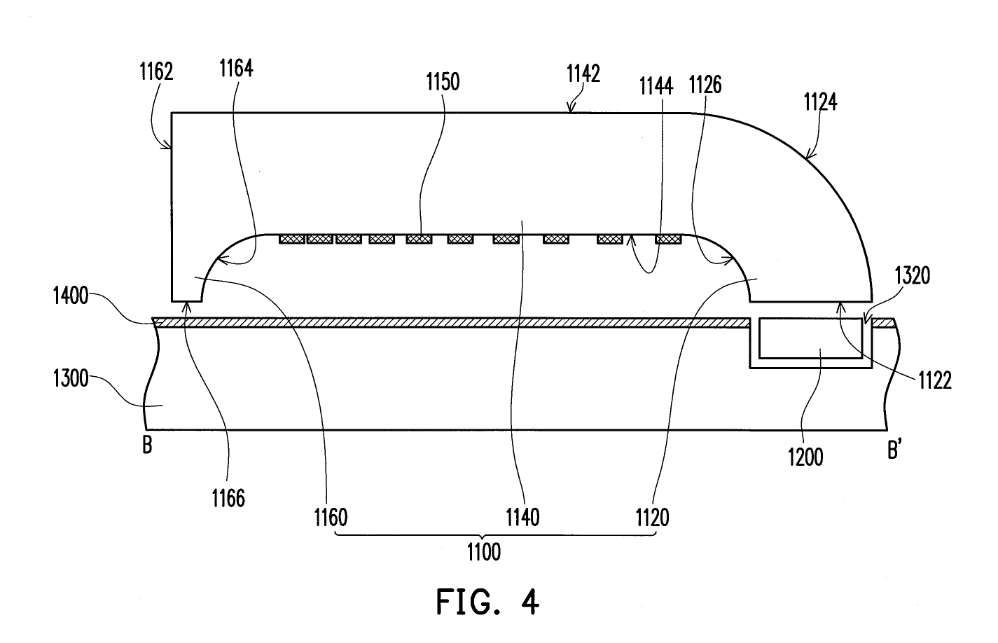

In one embodiment, the light guide unit 1100 may further include a plurality of scattering microstructures 1150 as illustrated in FIG. 4. These scattering microstructures 1150 are disposed on the second surface 1144 of the planar portion 1140. The density of the scattering microstructure 1150 may increase gradually along a direction from the second optical surface 1126 toward the third optical surface 1164. As such, the overall luminance and illumination uniformity of the surface light source provided by the light source module 1000 may be effective improved.

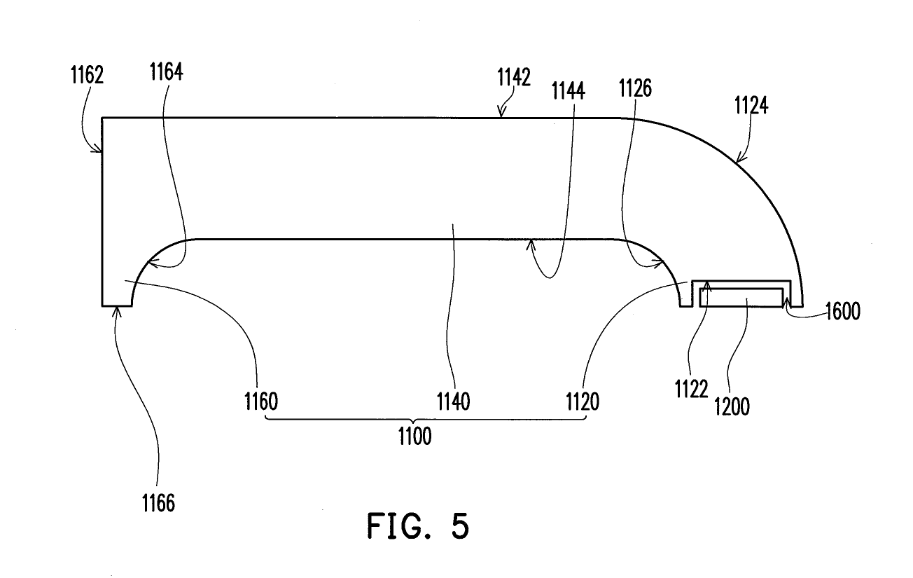

In addition, the light guide unit 1100 may also include a recessed portion 1600 as illustrated in FIG. 5. The recessed portion 1600 is disposed on the light incident surface 1122 of the first curved portion 1120 and is recessed into the light guide unit 1100 in a direction toward the first surface 1142. As such, the light source 1200 shown in FIGS. 1B and 2B may be disposed in the recessed portion 1600, and therefore, the substrate 1300 does not need to include the grooves 1320. In other words, the substrate 1300 may optionally include the grooves 1320 depending upon the structure of the light guide units 1100 or the actual requirements of the user, and examples of the grooves 1320 described herein are for the purposes of illustration only.

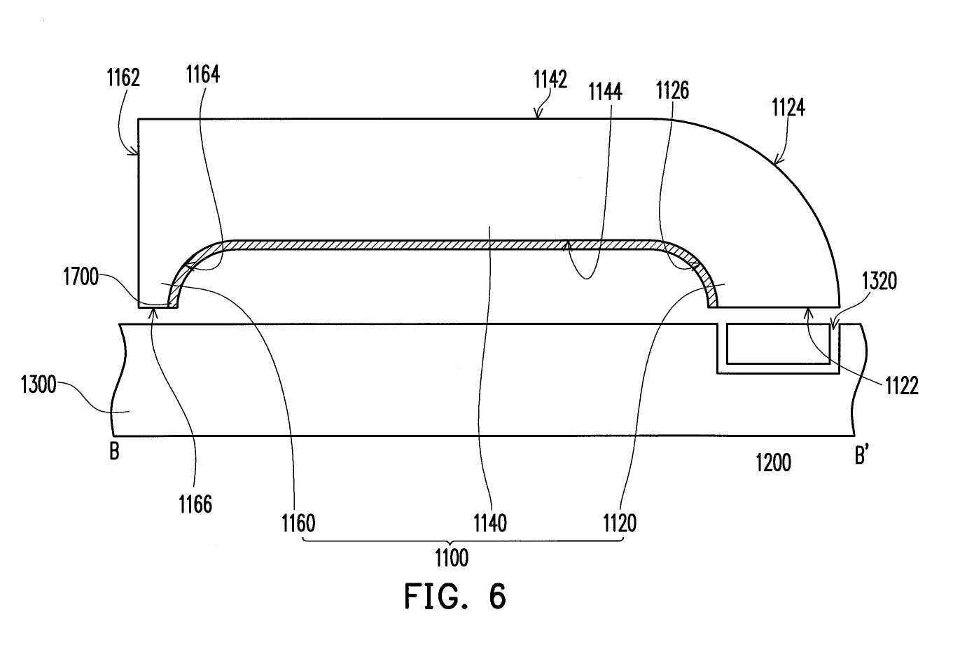

In another embodiment, the light guide unit 1100 may also include a reflection unit 1700 disposed on at least one of the second optical surface 1126, the second surface 1144, and the third optical surface 1164. While the reflection unit 1700 is illustrated as being disposed on each of the second optical surface 1126, the second surface 1144, and the third optical surface 1164 in FIG. 6, it is to be understood that the specific embodiment described herein is for the purposes of illustration only and should not be regarded as limiting. In other words, in the implementation shown in FIG. 6, the reflection unit 1400 illustrated in FIGS. 1B and 2B may be optionally disposed on the substrate 1300, and the invention is not intended to limit it to any particular embodiment.

In addition, the second curved portion 1160 may further include a support surface 1166 connecting the third surface 1162 and the third optical surface 1164, as shown in FIGS. 1B, 2B, 4, 5, and 6. In the embodiment, the support surface 1166 may be positioned in parallel with the light incident surface 1122, and both the support surface 1166 and the light incident surface 1122 may rest on the substrate 1300 shown in FIGS. 1B and 2B.

Noticeably, since the first optical surface 1124, the second optical surface 1126, and the third optical surface 1164 are configured as above, the overall thickness of the light guide units 1100 may be effectively reduced by appropriately configuring the surface curvatures of the first optical surface 1124, the second optical surface 1126, and the third optical surface 1164.

In summary, the embodiment or embodiments of the invention may have at least one of the following advantage. In the embodiments of the invention, the absolute values of the slopes of the first optical surface, the second optical surface, and the third optical surface with respect to the first surface gradually increase away from the first surface. Therefore, when the light beam is transmitted to the optical surfaces, the light beam is capable of being partially transmitted through these optical surfaces and partially reflected by these optical surfaces. This not only makes it possible to more effectively utilize and guide the light beam of the light source, but it also provides a more uniform light field formed by the light beam emerging out of the light guide units.

In addition, since the first optical surface, the second optical surface, and the third optical surface are configured as above, the overall thickness of the light guide units may be effectively reduced by appropriately configuring the surface curvatures of the first optical surface, the second optical surface, and the third optical surface. In addition, the overall thickness of the light source module employing the light guide unit described herein may also be reduced.

Besides, since the light guide unit includes the third optical surface, the possibility of forming the bright line between the adjacent the light guide units arranged in an array may be reduced when the light guide units are employed in the light source module, and thus the illumination uniformity of the surface light source provided by the light source module may be improved.

Furthermore, if a distance is maintained between the light guide units arranged in an array, the distance may not only help the light source module avoid the alignment error during assembly and the error due to thermal expansion of the material, but also an air gap between the adjacent light guide units is formed to facilitate the first optical surface reflecting the light beam under the principle of total reflection.

Moreover, the second surface of the light guide unit is provided with a plurality of scattering microstructures, and the density of the scattering microstructures may increase in a direction from the second optical surface toward the third optical surface. As such, the overall luminance and illumination uniformity of the surface light source provided by the light source module employing the light guide units described herein may be effectively improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A light guide unit comprising:
a first curved portion having a first optical surface, a second optical surface, and a light incident surface connecting the first optical surface and the second optical surface;
a planar portion having a first surface and a second surface opposite to the first surface, wherein the first optical surface is connected to the first surface, an absolute value of a slope of the first optical surface with respect to the first surface gradually increases near to the light incident surface, the second surface is connected to the second optical surface, and an absolute value of a slope of the second optical surface with respect to the second surface gradually increases near to the light incident surface; and
a second curved portion having a third surface and a third optical surface, wherein the planar portion connects the first curved portion and the second curved portion, the first surface connects the first optical surface and the third surface, the second surface connects the second optical surface and the third optical surface, and an absolute value of a slope of the third optical surface with respect to the second surface gradually increases away from the first surface.

2. The light guide unit according to claim 1, wherein the light guide unit is capable of guiding a light beam provided by a light source, the light beam is capable of entering the light guide unit via the light incident surface, when the light beam passing the light incident surface is transmitted to the first optical surface and the second optical surface, respectively, the first optical surface and the second optical surface are adapted to partially reflect the light beam such that a portion of the light beam is transmitted to the planar portion, the planar portion is adapted to transmit a portion of the light beam to the second curved portion, a portion of the light beam not reflected by the first optical surface is capable of emerging out of the light guide unit through the first optical surface, and the portion of the light beam from the first curved portion is capable of emerging out of the light guide unit through the first surface, and the portion of the light beam from the planar portion is capable of being reflected by the third optical surface to the third surface to emerge out of the light guide unit through the third surface.

3. The light guide plate according to claim 1, wherein each of the first optical surface, the second optical surface, and the third optical surface comprises a smooth curved surface or a surface formed by a plurality of planes connected to one another, and each of the absolute values of slopes of the planes with respect to the first surface gradually increases away from the first surface.

4. The light guide plate according to claim 1, further comprising a recessed portion disposed on the light incident surface of the first curved portion, wherein the recessed portion is recessed into the light guide unit in a direction toward the first surface.

5. The light guide plate according to claim 1, further comprising a reflection unit disposed on at least one of the second optical surface, the second surface, and the third optical surface.

6. The light guide plate according to claim 1, further comprising a plurality of scattering microstructures disposed on the second surface.

7. The light guide plate according to claim 6, wherein a density of the scattering microstructures gradually increases in a direction from the second optical surface toward the third optical surface.

8. The light guide plate according to claim 1, wherein the light incident surface is substantially parallel to the first surface.

9. The light guide plate according to claim 1, wherein the third surface is substantially perpendicular to the first surface.

10. The light guide plate according to claim 1, wherein the second curved portion further comprises a support surface connecting the third surface and the third optical surface.

11. A light source module comprising:
a plurality of light guide units arranged in an array, wherein the any two adjacent light guide units do not overlap with each other, and each of the light guide units comprises:
a first curved portion having a first optical surface, a second optical surface, and a light incident surface connecting the first optical surface and the second optical surface;
a planar portion having a first surface and a second surface opposite to the first surface, wherein the first optical surface is connected to the first surface, an absolute value of a slope of the first optical surface with respect to the first surface gradually increases near to the light incident surface, the second surface is connected to the second optical surface, and an absolute value of a slope of the second optical surface with respect to the second surface gradually increases near to the light incident surface;
a second curved portion having a third surface and a third optical surface, wherein the planar portion connects the first curved portion and the second curved portion, the first surface connects the first optical surface and the third surface, the second surface connects the second optical surface and the third optical surface, and an absolute value of a slope of the third optical surface with respect to the second surface gradually increases away from the first surface; and
a plurality of light sources, wherein each of the light sources is disposed adjacent to the light incident surface of a corresponding one of the light guide units, and a light beam provided by each of the light sources is capable of entering each of the light guide unit through the light incident surface thereof.

12. The light source module according to claim 11, wherein when the light beam passing the light incident surface is transmitted to the first optical surface and the second optical surface, respectively, the first optical surface and the second optical surface are adapted to partially reflect the light beam such that a portion of the light beam is transmitted to the planar portion, the planar portion is adapted to transmit a portion of the light beam to the second curved portion, a portion of the light beam not reflected by the first optical surface is capable of emerging out of the light guide unit through the first optical surface, the portion of the light beam from the first curved portion is capable of emerging out of the light guide unit through the first surface, and the portion of the light beam from the planar portion is capable of being reflected by the third optical surface to the third surface to emerge out of the light guide unit through the third surface.

13. The light source module according to claim 11, wherein each of the first optical surface, the second optical surface, and the third optical surface comprises a smooth curved surface or a surface formed by a plurality of planes connected to one another, and each of the absolute values of slopes of the planes with respect to the first surface gradually increases away from the first surface.

14. The light source module according to claim 11, wherein a distance is maintained between the any two adjacent light guide units arranged along a direction.

15. The light source module according to claim 14, wherein the distance is substantially equal to or less than 3% of a length of each of the light guide units along the direction.

16. The light source module according to claim 11, wherein, in the light guide units arranged in a direction, the first optical surface of one of the light guide units arranged in the direction faces the third surface of the adjacent one of the light guide units arranged in the direction, and the first optical surface of one of the light guide units arranged in the direction maintains a distance from the adjacent one of the light guide units arranged in the direction.

17. The light source module according to claim 11, further comprising a substrate, wherein the light guide units and the light sources are disposed on the substrate.

18. The light source module according to claim 17, wherein the substrate is provided with a plurality of grooves, and the light sources are disposed in the grooves, respectively.

19. The light source module according to claim 11, further comprising a plurality of reflection units disposed on the substrate, wherein each of the reflection units is disposed between a corresponding one of the light guide units and the substrate.

20. The light source module according to claim 11, wherein each of the light guide units further comprises a recessed portion disposed on the light incident surface of the first curved portion, and the recessed portion is recessed into the light guide unit in a direction toward the first surface.
